(19) United States
(12) Patent Application Publication
(10) Pub. No.: US 2013/0124436 A1
(43) Pub. Date: May 16, 2013

(54) Profiling Energy Consumption

(71) Applicants: Alvaro A. Cardenas Mora, Sunnyvale, CA (US); Daisuke Mashima, Atlanta, GA (US)

(72) Inventors: Alvaro A. Cardenas Mora, Sunnyvale, CA (US); Daisuke Mashima, Atlanta, GA (US)

(73) Assignee: Fujitsu Limited, Kanagawa (JP)

(21) Appl. No.: 13/297,033

(22) Filed: Nov. 15, 2011

(51) Int. Cl. G06N 5/04; G06F 15/18

(52) U.S. Cl. 706/12; 706/52

(57) ABSTRACT

Embodiments for detecting anomalous consumption of energy are provided. Information associated with energy consumption over a designated period of time is received. A threshold value is received. A classifier based on an Auto-Regressive Moving Average model is applied to the information and a result representing the likelihood of an attack is determined. The result is then analyzed to determine if it attained a threshold value. The information is then classified as indicating an attack. Additionally, embodiments for utilizing machine learning to train a classifier using training data to develop parameters for the auto-regressive moving average model are provided. Further, embodiments for evaluating the effectiveness of the parameters used in the Auto-Regressive Moving Average model to classify data are provided.

The present disclosure relates generally to profiling energy consumption.

Electric utilities charge an energy user for the amount of energy that the user consumes. This billing method provides an incentive for users to under-report to electric utilities the amount of energy actually consumed. This under-reporting is commonly known as energy theft or fraud. Experts estimate that energy theft currently accounts for billions of dollars in losses per year and is continuously increasing. This theft has significant negative consequences: electric utilities are unable to properly invest in their systems and are unable to accurately plan for future energy distribution needs. As a result, power outages become more common, which hampers economic development. Additionally, energy prices artificially raise for customers who pay for the energy that they actually consume.

Energy consumption is traditionally recorded using electromechanical meters. These meters record energy consumption mechanically via the interactions of metallic discs with magnetic fields. The energy consumption is then recorded by electric utilities. Traditionally, electric utilities recorded energy consumption directly via a display.

More recently, electric utilities have recorded energy consumption remotely via periodic transmissions from meters. Most recently, electric utilities are phasing in advanced meters based on the Advanced Metering Infrastructure (AMI). These meters transmit energy-consumption data more frequently than past meters—often in real or near-real time.

Despite the advanced technology used in AMI-based meters, they are still subject to tampering, resulting in energy fraud. Therefore, advanced methods for detecting energy consumption theft and other anomalies in energy consumption data are desirable.

### SUMMARY

Embodiments for detecting anomalous consumption of energy are described herein. Information associated with energy consumption over a designated period of time is received, along with a threshold value. A classifier based on an Auto-Regressive Moving Average model is then applied to the information, and a result representing the likelihood of an attack is determined. The result is then analyzed to determine if it attained a threshold value, and the information is thereafter classified as indicating an attack.

Additionally, embodiments for utilizing machine learning to train a classifier using training data to develop parameters for the auto-regressive moving average model are provided. Embodiments for evaluating the effectiveness of the parameters used in the Auto-Regressive Moving Average model to classify data are also provided.

The object and advantages of the invention will be realized and achieved by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 illustrates a system for particular embodiments.

FIG. 2 is a graph representing a scenario of anomalous energy consumption.

FIG. 3 describes a process for profiling energy consumption.

FIG. 4 describes a process for utilizing machine learning to train a classification engine to develop a model for profiling energy consumption.

FIG. 5A describes a process for evaluating a model for profiling energy consumption.

FIG. 5B describes a process for evaluating two or more models for profiling energy consumption.

FIG. 6 illustrates a network system for particular embodiments.

FIG. 7 illustrates a computer system for particular embodiments.

### DESCRIPTION OF EXAMPLE EMBODIMENTS

Embodiments disclosed herein provide methods for utilizing machine learning to detect the anomalous consumption of energy. In some embodiments, machine learning may be utilized to develop parameters for an auto-regressive moving average model by using training data to train a classifier. In further embodiments, the effectiveness of the parameters may be analyzed using the auto-regressive moving average model to classify data.

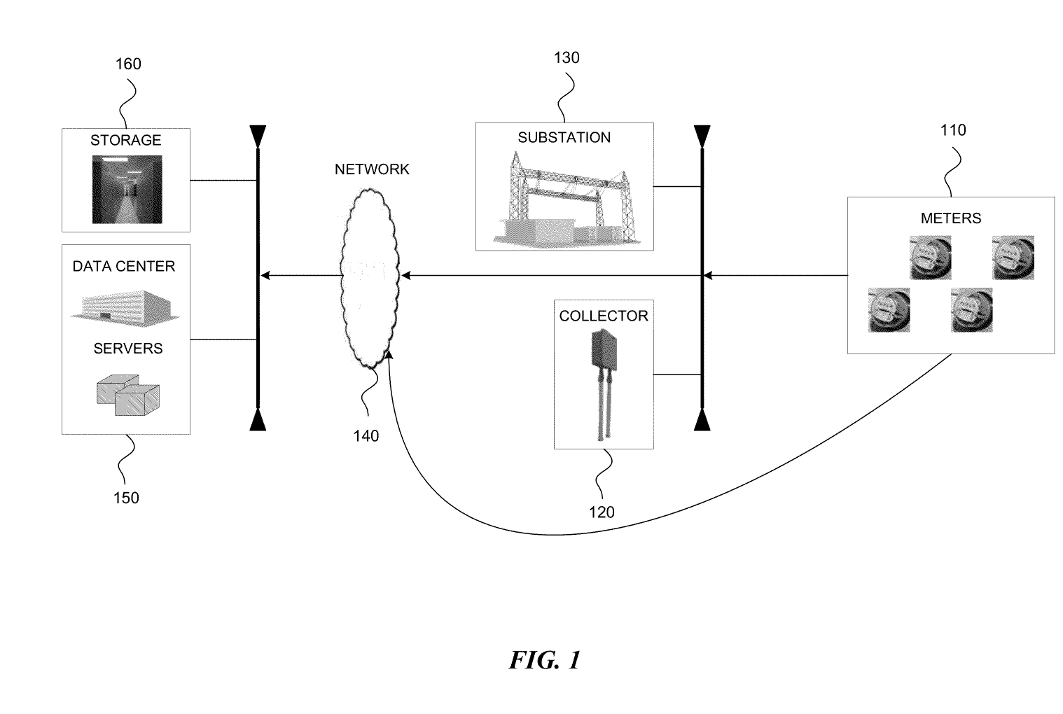

FIG. 1 illustrates an example system for particular embodiments. In particular embodiments, the system may have one or more meters 110. In some embodiments, meters 110 may record and transmit energy consumption data. In particular embodiments, meters 110 may utilize Advanced Metering Infrastructure (AMI) technology. In further embodiments, this energy consumption data may be transmitted as it is recorded. In some further embodiments, this energy consumption data may be transmitted in real time as it is recorded. In other further embodiments, this energy consumption data may be recorded, stored, and thereafter transmitted. In some further embodiments, this energy consumption data may be transmitted as a stream of data. In other further embodiments, this energy consumption data may be transmitted as packets of data.

In particular embodiments, the energy consumption data recorded and transmitted by meters 110 may be limited to an amount of energy consumed at a certain time. In further embodiments, the energy consumption data may include additional data. This additional data may include information identifying what appliances or devices are consuming electricity. This additional data may also include information identifying the source of the data set, including personal identities, addresses, phone numbers, geographic coordinates, etc.

In particular embodiments, the energy consumption data transmitted by meters 110 may be received by collector 120 and substation 130. In particular embodiments, collector 120 and substation 130 may be at substantially the same physical location. In other embodiments, collector 120 and substation 130 may be at different physical locations. In particular embodiments, collector 120 may be a physical component of substation 130. In other embodiments, collector 120 may be a separate component from substation 130 and may communicate with substation 130 over a network, whether it be a land-based network, a wireless network, etc.

In particular embodiments, there may be only one collector 120 and one substation 130 that receive data transmitted by meters 110. In other embodiments, there may be only one collector 120 and multiple substations 130 that receive data transmitted by meters 110. In other embodiments, there may be multiple collectors 120 and only one substation 130 that receive data transmitted by meters 110. In other embodiments, there may be multiple collectors 120 and multiple substations 130 that receive data transmitted by meters 110.

In particular embodiments, collector 120 and substation 130 may record and transmit the received energy consumption data. In further embodiments, collector 120 and substation 130 may transmit the energy consumption data as it is recorded. In some further embodiments, collector 120 and substation 130 may transmit the energy consumption data in real time as it is recorded. In other further embodiments, collector 120 and substation 130 may record, store, and thereafter transmit the energy consumption data. In some further embodiments, collector 120 and substation 130 may transmit this energy consumption data as a stream of data. In other further embodiments, collector 120 and substation 130 may transmit this energy consumption data as packets of data.

In particular embodiments, collector 120 and substation 130 may transmit the energy consumption data received by meters 110 to a network 140. In further embodiments, meters 110 may transmit the energy consumption data directly to network 140. In particular embodiments, network 140 may be an intranet, an extranet, a virtual private network (VPN), a local area network (LAN), a wireless LAN (WLAN), a wide area network (WAN), a metropolitan area network (MAN), a portion of the Internet, a cellular-technology-based, or another network 110 or a combination of two or more such networks 140. The present disclosure contemplates any suitable network 140. In particular embodiments, network 140 may transmit the received energy consumption data to data center and servers 150 and storage 160.

In particular embodiments, data center and servers 150 and storage 160 are at substantially the same physical location. In other embodiments, data center and servers 150 and storage 160 are at different physical locations. In particular embodiments, storage 160 is a physical component of data center and servers 150. In other embodiments, storage 160 is a separate component from data center and servers 150 and communicates with data center and servers 150 over a network, whether it be a land-based network, a wireless network, etc.

In particular embodiments, there may be only one storage 160 and one data center and servers 150 that receive data transmitted by network 140. In other embodiments, there may be only one storage 160 and multiple data centers and servers 150 that receive data transmitted by network 140. In other embodiments, there may be multiple storages 150 and only one data center and servers 150 that receive data transmitted by network 140. In other embodiments there may be multiple storages 160 and multiple data centers and servers 150 that receive data transmitted by network 140.

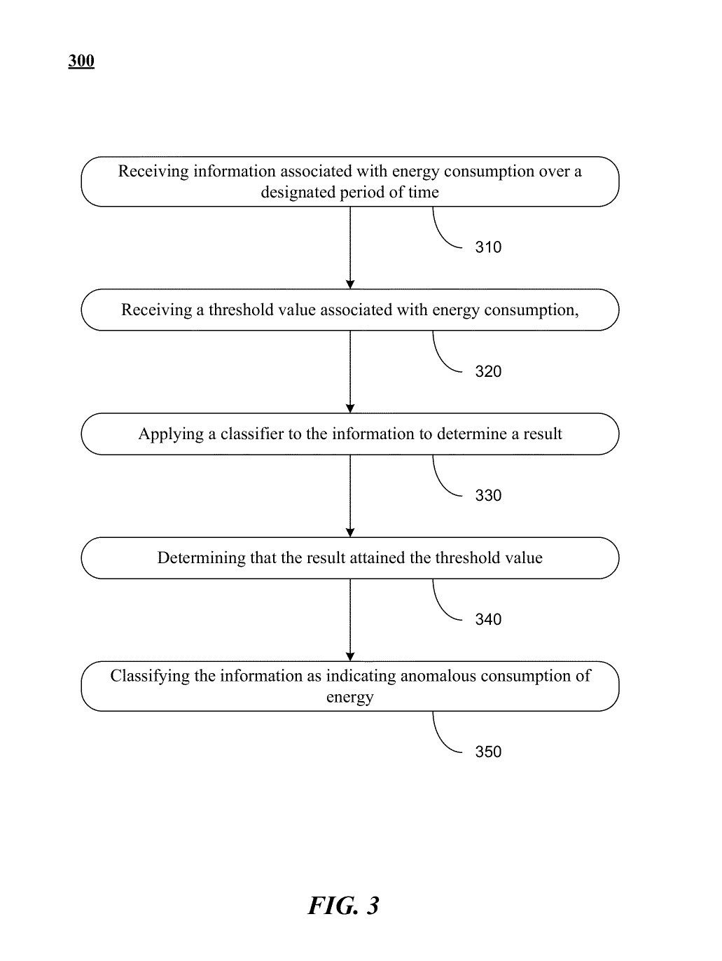

In particular embodiments, energy consumption data received by data center and servers 150 and storage 160 may be analyzed at data center and servers 150. In other embodiments, energy consumption data received by data center and servers 150 and storage 160 may be analyzed at storage 160. In other embodiments, energy consumption data received by data center and servers 150 and storage 160 may be analyzed at both data center and servers 150 and storage 160. In particular embodiments, the analysis undertaken by the data center and servers 150 and storage 160, jointly or independently, may consist of any or all of the methods demonstrated in FIGS. 3, 4, 5A, and 5B.

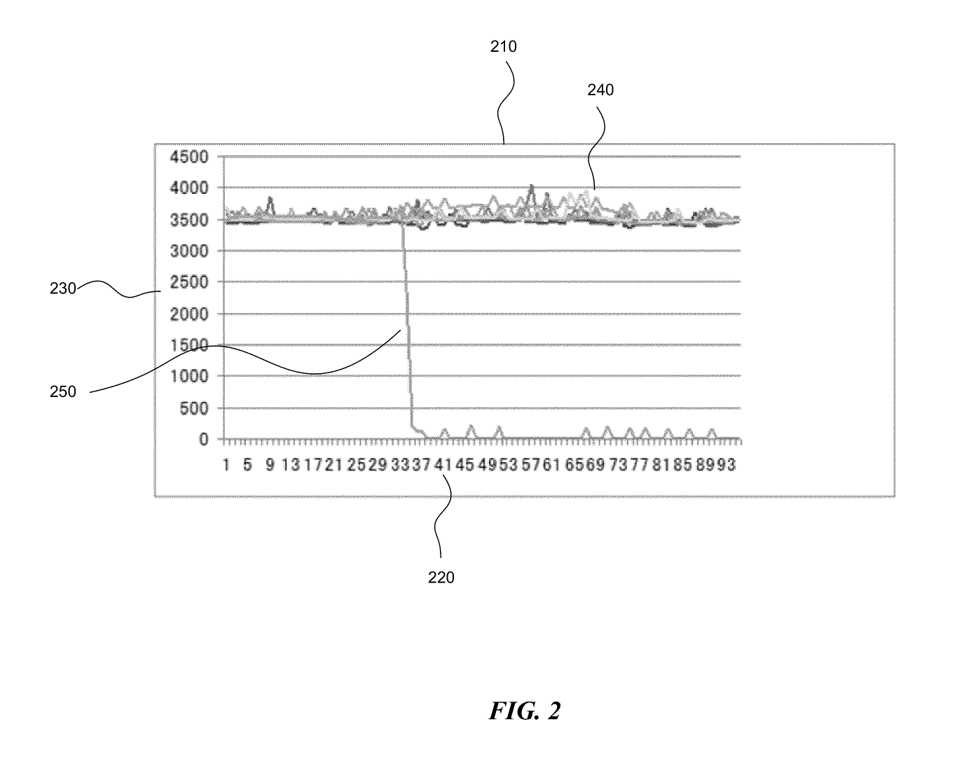

FIG. 2 illustrates a graph 210 representing an example scenario of anomalous energy consumption. In particular embodiments, axis 220 represents time, such that a displacement along axis 220 represents a change in time. Time may be described through the use of any time-based unit, whether it be milliseconds, seconds, hours, etc. In particular embodiments, axis 230 represents power consumption, such that a displacement along axis 230 represents a change in power consumption. Power consumption may be described through the use of any energy-based unit, whether it be kilowatt hours, watt hours, megajoules, horsepower, etc.

In particular embodiments, normal data sets 240 may contain information of power consumption at points in time. In other embodiments, normal data sets 240 may contain additional information, such as the source of the data set, including personal identities, addresses, phone numbers, geographic coordinates, etc. In further embodiments, normal data sets 240 may contain information derived from only one source, while in other embodiments normal data sets 240 may contain information derived from multiple sources.

In particular embodiments, anomalous data set 250 may represent anomalous power consumption data. In other embodiments, anomalous data set 250 may contain additional information, such as the source of the data set, including personal identities, addresses, phone numbers, geographic coordinates, etc. In further embodiments, anomalous data set 250 may contain information derived from only one source, while in other embodiments anomalous data set 250 may contain information derived from multiple sources.

In particular embodiments, such anomalous power consumption data may have only one cause, whether it be an equipment malfunction, an energy user altering his or her energy usage, an energy user falsifying the data relating to his or her true energy usage, etc. In further embodiments, data set 250 may represent an anomalous decrease, increase, or fluctuation in power consumption.

FIG. 3 describes an example process for profiling energy consumption. Information associated with energy consumption over a designated period of time is received or retrieved (310). In particular embodiments, this information may include normal data sets 240, anomalous data sets 250, or both. In particular embodiments, the received information may be associated with energy consumption as measured by one or more Advanced Metering Infrastructure-based devices. In further embodiments, the information may have been received from network 140. Thereafter, a threshold value associated with energy consumption is received or retrieved (320). In particular embodiments, this threshold value may represent the maximum number of false alarms that electric utilities are willing to tolerate. A classifier is then applied to the information to determine a result (330). In particular embodiments, this classifier is applied to the information using an Auto-Regressive Moving Average (ARMA) model. In other embodiments, algorithms other than ARMA models may be used, including Moving Average (MA) models, Auto-Regressive (AR) models, Auto-Regressive Integrated Moving Average (ARIMA) models, Auto-Regressive Moving Average with eXogeneous inputs (ARMAX) models, Linear Regression (LR) models, and Hidden Markov (HM) models. The goal of the model may be to predict the energy consumption value that it will receive at the next time step. In particular embodiments, an ARMA model may be based upon algorithm no. 1 below:

$${Y}_{K + 1} = {\sum }_{i = 1}^{p} {A}_{i} {Y}_{k - i} + {\sum }_{j = 0}^{q} {B}_{i} ( {V}_{k - j} - γ ) \qquad ( 1 )$$

In particular embodiments, the ARMA model may utilize a set of parameters associated with a particular energy consumer. A particular energy consumer may comprise any measurable block of energy consumption, e.g., a house, a room in a house, an office building, a floor in an office building, an apartment complex, an apartment unit, an individual circuit within a single structure, a single power outlet, a complex of buildings (e.g., a block of dormitories), a city block, a small town, a sector of a power grid, or any portion of the aforementioned.

In the ARMA model, the variables are defined as follows: Y_{K+1} is the predicted energy consumption; Aᵢ are weights of the auto-regression; p is the number of auto-regression terms; Bᵢ are the weights of the moving average; q is the number of moving average terms; Vₖ is the error between the actual energy consumption Yₖ and the predicted energy consumption from the model Y_{K+1}; and γ is a parameter representing a change in the mean, with respect to the ARMA process. If previous ARMA parameters fit the energy consumption, γ should be less than or substantially equal to zero, and γ is likely not non-anomalous. If, however the previous ARMA parameters do not fit the energy consumption, γ should be greater than zero, and γ is likely anomalous. In particular embodiments, γ may be determined through a generalized likelihood-ratio test. In particular embodiments, the generalized likelihood-ratio test may utilize algorithm no. 2, shown below, to determine the maximum where γ is greater than zero:

$${\sum }_{i = 1}^{N} ( \frac{{ɛ}_{i} γ}{σ} - \frac{{γ}^{2}}{2 σ} ) \qquad ( 2 )$$

In the generalized likelihood-ratio test, γ is the aforementioned parameter and ε is the error, which is the difference between the value predicted by the ARMA model Ŷ and the received value Y for each step. N is the number of time steps, and σ is the standard deviation of the error.

After the result has been determined, that result is compared with the threshold value to determine if the result attained the threshold value (340). In particular embodiments, the result has attained the threshold value if it is greater than the threshold value. In other embodiments, the result has attained the threshold value if it is substantially equal to the threshold value. The information is then classified as indicating anomalous consumption of energy (350). If the result attained the threshold value, the information is classified as positively indicating anomalous consumption of energy. If the result did not attain the threshold value, the information is classified as not indicating anomalous consumption of energy. In particular embodiments, anomalous power consumption information may have one or more cause, whether it be an equipment malfunction, an energy user altering his or her energy usage, an energy user falsifying the data relating to his or her true energy usage (e.g., an “attack”), etc. In further embodiments, anomalous power consumption information indicating an attack may represent a reduction in energy consumption.

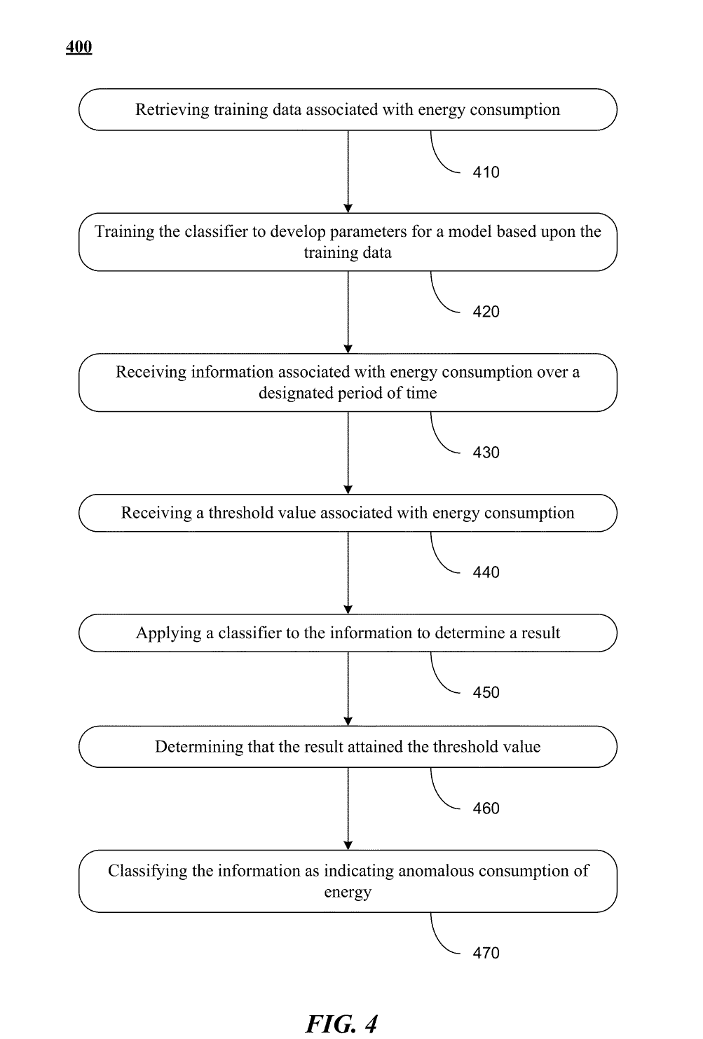

FIG. 4 describes an example process for utilizing machine learning to train an example classification engine to develop a model for profiling energy consumption. Training data associated with energy consumption is received or retrieved (410). In particular embodiments, the received information may be associated with energy consumption that was measured by one or more Advanced Metering Infrastructure-based devices. In further embodiments, the information may be received from storage 160. The classifier is then trained to develop parameters for a model based upon the training data (420). In particular embodiments, this classifier is trained through learning parameters for an Auto-Regressive Moving Average (ARMA) model. In other embodiments, parameters may be learned for algorithms other than ARMA models, including Moving Average (MA) models, Auto-Regressive (AR) models, Auto-Regressive Integrated Moving Average (ARIMA) models, Auto-Regressive Moving Average with eXogeneous inputs (ARMAX) models, Linear Regression (LR) models, and Hidden Markov (HM) models.

Algorithm no. 3, shown below, presents an example machine-learning algorithm to determine the parameters for an ARMA model:

$${\hat{Y}}_{K + 1} = {\sum }_{i = 1}^{p} {A}_{i} {Y}_{k - i} + {\sum }_{j = 0}^{q} {B}_{i} {V}_{k - j} \qquad ( 3 )$$

In this example ARMA model, the parameters are defined as follows: Ŷ_{K+1} is the predicted energy consumption; Aᵢ

are weights of the moving average; p is the number of terms to average; Bᵢ are the weights of the error average; q is the number of error terms to average; and Vₖ is the error between the actual energy consumption Yₖ and the predicted energy consumption from the model Ŷ_{K+1}. The Aᵢ, Bᵢ, p, and q parameters are learned by using the Yule-Walker equations and the Akaike information criterion.

In particular embodiments, the training data may represent one or more energy consumption scenarios, and the classifier may be trained to classify the one or more energy consumption scenarios as normal. In particular embodiments, the training data may be associated with a particular energy consumer, and the parameters for the ARMA model may be developed to recognize the one or more energy consumption scenarios as normal for the particular energy consumer. In particular embodiments, the training data represents a historical set of actual real-world data associated with the particular energy consumer that is deemed to represent a period of “normal usage” for that particular energy consumer.

Information associated with energy consumption over a designated period of time is then received or retrieved (430) in substantially the same manner as step 310 in method 300. A threshold value associated with energy consumption is then received or retrieved (440) in substantially the same manner as step 320 in method 300. A classifier is then applied to the information to determine a result (450) in substantially the same manner as step 330 in method 300. After the result has been determined, that result is compared with the threshold value to determine if the result attained the threshold value (460) in substantially the same manner as step 340 in method 300. The information is then classified as indicating anomalous consumption of energy (470) in substantially the same manner as step 350 in method 300.

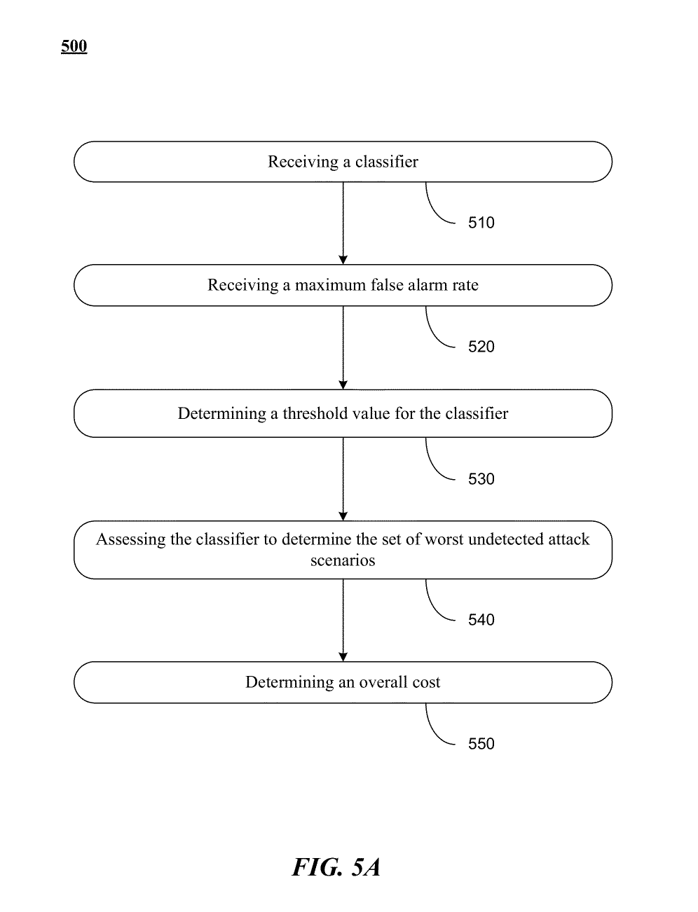

FIG. 5A describes an example process for evaluating a model for profiling energy consumption. Information associated with a classifier is received or retrieved (510). In particular embodiments, the classifier may detect anomalous energy consumption and predict the likelihood of an attack. In particular embodiments, the classifier may be based upon an Auto-Regressive Moving Average (ARMA) model. In other embodiments, the classifier may be based on algorithms other than ARMA models, including Moving Average (MA) models, Auto-Regressive (AR) models, Auto-Regressive Integrated Moving Average (ARIMA) models, Auto-Regressive Moving Average with eXogeneous inputs (ARMAX) models, Linear Regression (LR) models, and Hidden Markov (HM) models. A maximum false alarm rate is then received or retrieved (520). In particular embodiments, this maximum false alarm rate is the maximum false alarm rate tolerated by electric utilities. A threshold value is then determined for the classifier (530). In particular embodiments, this threshold value maximizes the false alarms for the classifier without exceeding the maximum false alarm rate. The classifier is then assessed to determine the set of worst undetected attack scenarios (540), where the worst undetected attack scenario for the classifier is defined as the largest difference between the actual energy consumption and the predicted energy consumption. The classifier's overall cost is then determined (550). In particular embodiments, the worst undetected attack scenario for the classifier is defined as the cost of the classifier.

FIG. 5B describes an example process for evaluating two or more models for profiling energy consumption. Information associated with a plurality of classifiers is received or retrieved (510). In particular embodiments, each classifier may detect anomalous energy consumption and predicts the likelihood of an attack. In particular embodiments, at least one classifier may be based upon an Auto-Regressive Moving Average (ARMA) model. In other embodiments, classifiers may be based on algorithms other than ARMA models, including Moving Average (MA) models, Auto-Regressive (AR) models, Auto-Regressive Integrated Moving Average (ARIMA) models, Auto-Regressive Moving Average with eXogeneous inputs (ARMAX) models, Linear Regression (LR) models, and Hidden Markov (HM) models. A maximum false alarm rate is then received or retrieved (520). In particular embodiments, this maximum false alarm rate is the maximum false alarm rate tolerated by electric utilities. A threshold value is then determined for each of the one or more classifiers (530). In particular embodiments, this threshold value maximizes the false alarms for each of the one or more classifiers without exceeding the maximum false alarm rate. Each of the one or more classifiers is then assessed to determine the set of worst undetected attack scenarios for each of the one or more classifiers (540), where the worst undetected attack scenario for each of the one or more classifiers is defined as the largest difference between the actual energy consumption and the predicted energy consumption. In particular embodiments, the worst undetected attack scenario for each of the one or more classifiers is defined as the cost of each of the one or more classifiers. Each of the one or more classifiers is then ranked by cost (560). A chosen classifier is then selected from the one or more classifiers (570). In particular embodiments, the selected classifier may be the classifier with the lowest cost.

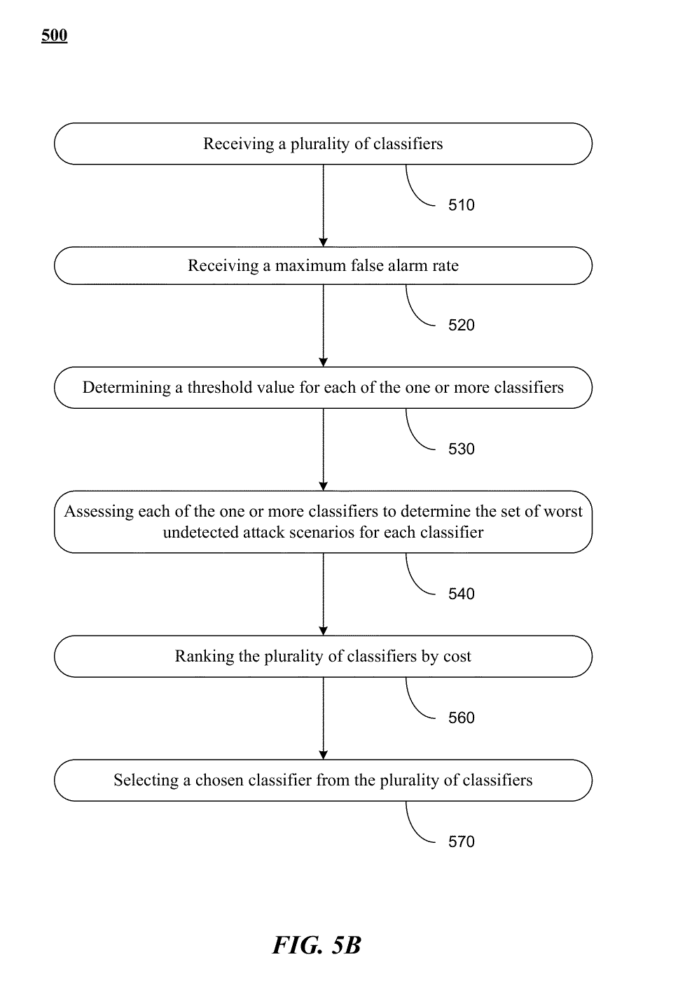

FIG. 6 illustrates an example network system 600 suitable for particular embodiments. Network environment 600 includes a network 610 communicably coupling one or more servers 620, one or more meters 630, and/or one or more clients 660. In particular embodiments, network 610 is an intranet, an extranet, a virtual private network (VPN), a local area network (LAN), a wireless LAN (WLAN), a wide area network (WAN), a metropolitan area network (MAN), a portion of the Internet, a cellular-technology-based, or another network 610 or a combination of two or more such networks 610. The present disclosure contemplates any suitable network 610.

One or more links 650 couple a server 620, a meter 630, or a client 660 to network 610. In particular embodiments, one or more links 650 each includes one or more wireline, wireless, or optical links 650. In particular embodiments, one or more links 650 each includes an intranet, an extranet, a VPN, a LAN, a WLAN, a WAN, a MAN, a portion of the Internet, or another link 650 or a combination of two or more such links 650. The present disclosure contemplates any suitable links 650 coupling servers 620, meters 630, and/or clients 660 to network 610.

In particular embodiments, each server 620 may be a unitary server or may be a distributed server spanning multiple computers or multiple datacenters. Servers 620 may be of various types, such as, for example and without limitation, web server, news server, mail server, message server, advertising server, file server, application server, exchange server, database server, proxy server, or other server suitable for performing particular functions or processes described herein. In particular embodiments, each server 620 may include hardware, software, or embedded logic components or a combination of two or more such components for carrying out the appropriate functionalities implemented or supported by server 620. For example, a web server is generally capable of hosting websites containing web pages or particular elements of web pages. More specifically, a web server may host HTML files or other file types, or may dynamically create or provide [or implement] files upon a request, and communicate them to clients 660 in response to HTTP or other requests from clients 660. A mail server is generally capable of providing electronic mail services to various clients 660. A database server is generally capable of providing an interface for managing data stored in one or more data stores. In particular embodiments, server 620 is generally capable of receiving and/or retrieving data from meters 630 to perform functions and/or processes described herein. In particular embodiments, server 620 is generally capable of receiving and/or retrieving data from clients 660 to perform typical functions and/or processes for performing monitoring, administration, configuration, and/or management functions in relation to other elements of network system 600.

In particular embodiments, one or more data storages 640 may be communicatively linked to one or more severs 620 via one or more links 650. In particular embodiments, data storages 640 may be used to store various types of information. In particular embodiments, the information stored in data storages 640 may be organized according to specific data structures. In particular embodiment, each data storage 640 may be a relational database. Particular embodiments may provide interfaces that enable servers 620 and/or client 660 to manage, e.g., retrieve, modify, add, or delete, the information stored in data storage 640.

In particular embodiments, each meter 630 may be an electronic device including hardware, software, or embedded logic components or a combination of two or more such components and capable of carrying out the appropriate functionalities implemented or supported by meter 630. In particular embodiments, meter 630 may comprise any conventional meter capable of performing functions and/or processes as described herein. Such conventional meters are typically solid state, electronic meters that collect time-based data and may transmit the collected data over networks such as Broadland over Power Line (BPL), Power Line Communications (PLC), Fixed Radio Frequency (RF) networks, intranet, extranet, virtual private networks (VPNs), local area networks (LANs), wireless LANs (WLANs), wide area networks (WANs), metropolitan area network (MANs), portions of the Internet, cellular-technology-based, or other networks or a combination of two or more such networks. In particular embodiments, such meters may enable two-way communications between a meter and an energy provider.

In particular embodiments, each client 660 may be an electronic device including hardware, software, or embedded logic components or a combination of two or more such components and capable of carrying out the appropriate functionalities implemented or supported by client 660. For example and without limitation, a client 660 may be a desktop computer system, a notebook computer system, a netbook or tablet computer system, a handheld electronic computer system, or a mobile telephone incorporating elements of a computer system. The present disclosure contemplates any suitable clients 660. A client 660 may enable a network user at client 660 to access network 610. A client 660 may enable its user to communicate with other users at other clients 660.

A client 660 may have a web browser 632, such as MICROSOFT INTERNET EXPLORER, GOOGLE CHROME or MOZILLA FIREFOX, and may have one or more add-ons, plug-ins, or other extensions, such as TOOLBAR or YAHOO TOOLBAR. A user at client 660 may enter a Uniform Resource Locator (URL) or other address directing the web browser 632 to a server 620, and the web browser 632 may generate a Hyper Text Transfer Protocol (HTTP) request and communicate the HTTP request to server 620. Server 620 may accept the HTTP request and communicate to client 660 one or more Hyper Text Markup Language (HTML) files responsive to the HTTP request. Client 660 may render a web page based on the HTML files from server 620 for presentation to the user. The present disclosure contemplates any suitable web page files. As an example and not by way of limitation, web pages may render from HTML files, Extensible Hyper Text Markup Language (XHTML) files, or Extensible Markup Language (XML) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a web page encompasses one or more corresponding web page files (which a browser may use to render the web page) and vice versa, where appropriate.

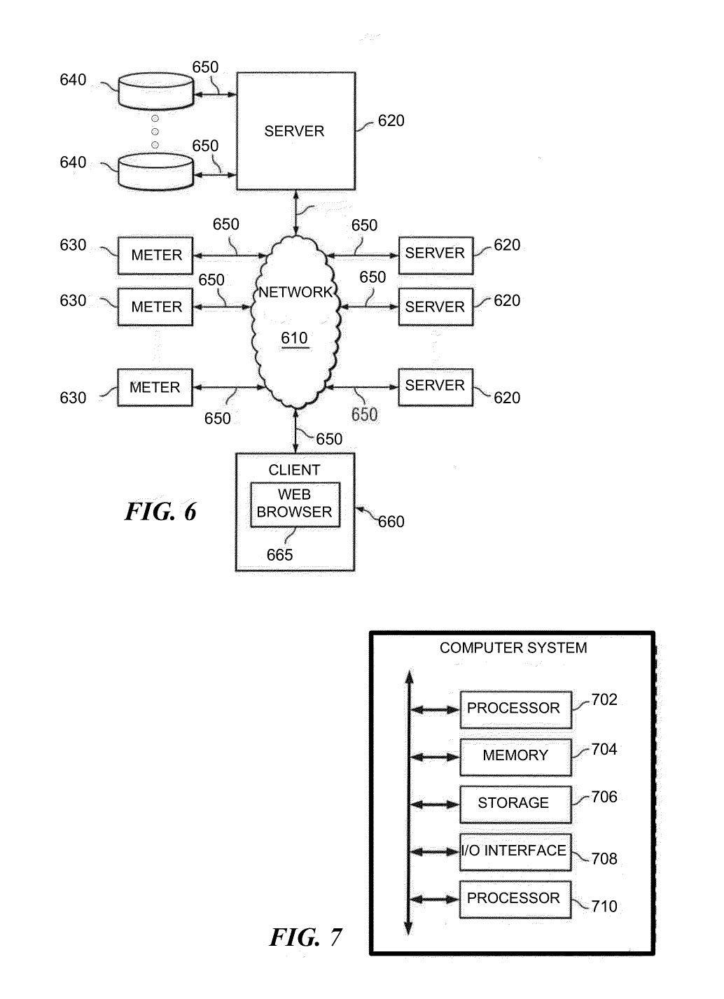

FIG. 7 illustrates an example computer system 700 for particular embodiments. In particular embodiments, one or more computer systems 700 perform one or more steps of one or more methods described or illustrated herein. In particular embodiments, one or more computer systems 700 provide functionality described or illustrated herein. In particular embodiments, software running on one or more computer systems 700 performs one or more steps of one or more methods described or illustrated herein or provides functionality described or illustrated herein. Particular embodiments include one or more portions of one or more computer systems 700.

This disclosure contemplates any suitable number of computer systems 700. This disclosure contemplates computer system 700 taking any suitable physical form. As example and not by way of limitation, computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, computer system 700 may include one or more computer systems 700; be unitary or distributed; span multiple locations; span multiple machines; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 702, memory 704, storage 706, an input/output (I/O) interface 708, a communication interface 710, and a bus 712. Although this disclosure describes and illustrates a particular computer system having a particular number of particular components in a particular arrangement, this disclosure contemplates any suitable computer system having any suitable number of any suitable components in any suitable arrangement.

In particular embodiments, processor 702 includes hardware for executing instructions, such as those making up a computer program. As an example and not by way of limitation, to execute instructions, processor 702 may retrieve (or fetch) the instructions from an internal register, an internal cache, memory 704, or storage 706; decode and execute them; and then write one or more results to an internal register, an internal cache, memory 704, or storage 706. In particular embodiments, processor 702 may include one or more internal caches for data, instructions, or addresses. The present disclosure contemplates processor 702 including any suitable number of any suitable internal caches, where appropriate. As an example and not by way of limitation, processor 702 may include one or more instruction caches, one or more data caches, and one or more translation lookaside buffers (TLBs). Instructions in the instruction caches may be copies of instructions in memory 704 or storage 706, and the instruction caches may speed up retrieval of those instructions by processor 702. Data in the data caches may be copies of data in memory 704 or storage 706 for instructions executing at processor 702 to operate on; the results of previous instructions executed at processor 702 for access by subsequent instructions executing at processor 702 or for writing to memory 704 or storage 706; or other suitable data. The data caches may speed up read or write operations by processor 702. The TLBs may speed up virtual-address translation for processor 702. In particular embodiments, processor 702 may include one or more internal registers for data, instructions, or addresses. The present disclosure contemplates processor 702 including any suitable number of any suitable internal registers, where appropriate. Where appropriate, processor 702 may include one or more arithmetic logic units (ALUs); be a multi-core processor; or include one or more processors 702. Although this disclosure describes and illustrates a particular processor, this disclosure contemplates any suitable processor.

In particular embodiments, memory 704 includes main memory for storing instructions for processor 702 to execute or data for processor 702 to operate on. As an example and not by way of limitation, computer system 700 may load instructions from storage 706 or another source (such as, for example, another computer system 700) to memory 704. Processor 702 may then load the instructions from memory 704 to an internal register or internal cache. To execute the instructions, processor 702 may retrieve the instructions from the internal register or internal cache and decode them. During or after execution of the instructions, processor 702 may write one or more results (which may be intermediate or final results) to the internal register or internal cache. Processor 702 may then write one or more of those results to memory 704. In particular embodiments, processor 702 executes only instructions in one or more internal registers or internal caches or in memory 704 (as opposed to storage 706 or elsewhere) and operates only on data in one or more internal registers or internal caches or in memory 704 (as opposed to storage 706 or elsewhere). One or more memory buses (which may each include an address bus and a data bus) may couple processor 702 to memory 704. Bus 712 may include one or more memory buses, as described below. In particular embodiments, one or more memory management units (MMUs) reside between processor 702 and memory 704 and facilitate accesses to memory 704 requested by processor 702. In particular embodiments, memory 704 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. The present disclosure contemplates any suitable RAM. Memory 704 may include one or more memories 704, where appropriate. Although this disclosure describes and illustrates particular memory, this disclosure contemplates any suitable memory.

In particular embodiments, storage 706 includes mass storage for data or instructions. As an example and not by way of limitation, storage 706 may include an HDD, a floppy disk drive, flash memory, an optical disc, a magneto-optical disc, magnetic tape, or a Universal Serial Bus (USB) drive or a combination of two or more of these. Storage 706 may include removable or non-removable (or fixed) media, where appropriate. Storage 706 may be internal or external to computer system 700, where appropriate. In particular embodiments, storage 706 is non-volatile, solid-state memory. In particular embodiments, storage 706 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 706 taking any suitable physical form. Storage 706 may include one or more storage control units facilitating communication between processor 702 and storage 706, where appropriate. Where appropriate, storage 706 may include one or more storages 706. Although this disclosure describes and illustrates particular storage, this disclosure contemplates any suitable storage.

In particular embodiments, I/O interface 708 includes hardware, software, or both providing one or more interfaces for communication between computer system 700 and one or more I/O devices. Computer system 700 may include one or more of these I/O devices, where appropriate. One or more of these I/O devices may enable communication between a person and computer system 700. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 708 for them. Where appropriate, I/O interface 708 may include one or more device or software drivers enabling processor 702 to drive one or more of these I/O devices. I/O interface 708 may include one or more I/O interfaces 708, where appropriate. Although this disclosure describes and illustrates a particular I/O interface, this disclosure contemplates any suitable I/O interface.

In particular embodiments, communication interface 710 includes hardware, software, or both providing one or more interfaces for communication (such as, for example, packet-based communication) between computer system 700 and one or more other computer systems 700 or one or more networks. As an example and not by way of limitation, communication interface 710 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 710 for it. As an example and not by way of limitation, computer system 700 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 700 may include any suitable communication interface 710 for any of these networks, where appropriate. Communication interface 710 may include one or more communication interfaces 710, where appropriate. Although this disclosure describes and illustrates a particular communication interface, this disclosure contemplates any suitable communication interface.

In particular embodiments, bus 712 includes hardware, software, or both coupling components of computer system 700 to each other. As an example and not by way of limitation, bus 712 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 712 may include one or more buses 712, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 702 (such as, for example, one or more internal registers or caches), one or more portions of memory 704, one or more portions of storage 706, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art may comprehend. Similarly, where appropriate, the appended claims encompass all changes, substitutions, variations, alterations, and modifications to the example embodiments herein that a person having ordinary skill in the art may comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising, by one or more computer systems:
receiving information associated with energy consumption as measured over a designated period of time;
receiving a threshold value associated with energy consumption, wherein a possible attack is indicated when the threshold value is attained;
applying, using one or more processors associated with the one or more computer systems, a classifier to the information to determine a result representing a likelihood of an attack, wherein the classifier is based on an auto-regressive moving average model;
determining, using the one or more processors, that the result attained the threshold value; and
classifying the information as indicating an attack.

2. The method of claim 1, wherein the auto-regressive moving average model utilizes a set of parameters associated with a particular energy consumer.

3. The method of claim 1, wherein applying the classifier to determine the result representing the likelihood of an attack comprises:
determining a maximum likelihood estimate of possible attack, based upon parameters for the auto-regressive moving average model; and
applying a generalized likelihood-ratio test.

4. The method of claim 1, wherein an average number of false alarms does not exceed a maximum false alarm rate.

5. The method of claim 1, wherein the received information is associated with energy consumption as measured by one or more Advanced Metering Infrastructure-based devices.

6. The method of claim 1, wherein the information indicating an attack represents a reduction in energy consumption.

7. The method of claim 1, further comprising:
retrieving training data associated with energy consumption; and
training, using the one or more processors, the classifier to develop parameters for the auto-regressive moving average model based upon the training data.

8. The method of claim 7, wherein the training data represents one or more energy consumption scenarios, and wherein the classifier is trained to classify the one or more energy consumption scenarios as normal.

9. The method of claim 8, wherein the training data is associated with a particular energy consumer, and wherein the parameters for the auto-regressive moving average model are developed to recognize the one or more energy consumption scenarios as normal for the particular energy consumer.

10. The method of claim 9, wherein the training data comprises historical data associated with the particular energy consumer, wherein the historical data is deemed to represent a period of normal usage for the particular energy consumer.

11. A method comprising, by one or more computer systems:
receiving a plurality of classifiers, wherein each classifier detects anomalous energy consumption and predicts a likelihood of an attack;
receiving a maximum false alarm rate;
determining a threshold value for each of the one or more classifiers, wherein the determining is based on the maximum false alarm rate;
assessing each of the one or more classifiers to determine a set of worst undetected attack scenarios for each classifier, wherein the assessing is based upon a cost of each scenario;
ranking the plurality of classifiers by overall cost, wherein the overall cost for each classifier is based on the maximum false alarm rate and the set of worst undetected attack scenarios for the classifier; and
selecting a chosen classifier from the plurality of classifiers based on the ranking

12. The method of claim 11, wherein determining the threshold value for a classifier comprises maximizing a number of false alarms without exceeding the maximum false alarm rate.

13. The method of claim 11, wherein the set of worst undetected attack scenarios is determined based upon a maximum loss for each attack scenario.

14. The method of claim 13, wherein the maximum loss for each attack scenario comprises a difference between actual energy consumption and predicted energy consumption.

15. The method of claim 11, wherein at least one classifier is based upon an auto-regressive moving average model.

16. A method comprising, by one or more computer systems:
receiving a classifier based on an auto-regressive moving average model, wherein the classifier detects anomalous energy consumption and predicts a likelihood of an attack;
receiving a maximum false alarm rate;
determining a threshold value, wherein the assessing is based on the maximum false alarm rate;
assessing the classifier to determine a set of worst undetected attack scenarios, wherein the determination is based upon a cost of each scenario; and
determining an overall cost, wherein the overall cost is based on the maximum false alarm rate and the set of worst undetected attack scenarios.

17. The method of claim 16, wherein determining the threshold value comprises maximizing a number of false alarms without exceeding the maximum false alarm rate.

18. The method of claim 16, wherein the set of worst undetected attack scenarios is determined based upon a maximum loss for each attack scenario.

19. The method of claim 18, wherein the maximum loss for each attack scenario comprises a difference between actual energy consumption and predicted energy consumption.

20. The method of claim 16, wherein the auto-regressive moving average model utilizes a set of parameters associated with a particular energy consumer.
